(19) United States
(12) Patent Application Publication
(10) Pub. No.: US 2009/0038996 A1
(43) Pub. Date: Feb. 12, 2009

(54) COIN RETRIEVAL FROM REFUSE

(76) Inventor: Kevin J. Sedore, Royal Palm Beach, FL (US)

Correspondence Address: BABCOCK & WILCOX POWER GENERATION GROUP, INC., PATENT DEPARTMENT, 20 SOUTH VAN BUREN AVENUE, BARBERTON, OH, 44203, US

(21) Appl. No.: 11/834,247

(22) Filed: Aug. 6, 2007

(51) Int. Cl. B07B 4/06

(52) U.S. Cl. 209/134

(57) ABSTRACT

An apparatus and method for screening out coins from a non-ferrous residue throughput of a resource recovery facility, and including a trommel comprised of an open ended drum. The cylindrical portion of the drum is formed of spaced-apart elongate pipe members defining a screen extending between the inlet end and the outlet end of the drum. The drum is rotatable along its longitudinal axis and positioned such that the non-ferrous residue throughput moves from the inlet end to the outlet end as the drum rotates and tumbles the residue in a progressive helix pattern to cause the screening out of coins from the residue throughput, with the screened coins exiting through the space between the elongate pipe members and the remaining residue throughput being discharged through the outlet end of the drum.

### FIELD AND BACKGROUND OF THE INVENTION

The present invention relates, in general, to a screening method and apparatus and, in particular, to the recovery of coins from the non-ferrous residue throughput of a resource recovery facility.

The disposal of the increasing volume of municipal solid waste, as part of the more general problem of environment, has caused rising concern in recent years. Our municipal solid waste offers an opportunity for material recovery. To the extent that materials can be efficiently separated, the value or profit derived from such material recovery is enhanced.

### SUMMARY OF THE INVENTION

In accordance with the present invention, a non-ferrous residue throughput enters the inlet end of a rotating trommel drum and is tumbled, in a progressive helix pattern toward the outlet of the drum, while causing coins in the residue throughput to be centrifugally deflected in the direction of the screen which is comprised of the drum circumferential sidewall and has discharge openings disposed along the length of the drum.

On a narrower but no less gainful scale, the present invention provides a rotating screening drum which enhances the recovery of coins from a non-ferrous residue throughput as it flows therethrough.

The present invention provides an apparatus for screening out coins from a non-ferrous residue throughput of a resource recovery facility, and includes a trommel comprised of a cylindrical drum having an inlet or intake end and an outlet or discharge end. The cylindrical portion of the drum is comprised of spaced-apart elongate members forming a screen extending between the inlet and outlet ends of the drum. The elongate members are joined by transverse bracing members. The drum is rotatable along its longitudinal axis and positioned such that the non-ferrous residue throughput moves from the inlet end to the outlet end as the drum rotates and tumbles the residue in a progressive helix pattern to cause the screening out coins from the residue throughput, with the screened coins exiting through the space between the elongate members, with the remaining residue throughput being discharged through the outlet end of the drum.

A variable frequency drive motor and gearbox combination controls the drum rotation speed. The drum includes drive wheels and idler wheels frictionally engaged with collars fixedly secured to the drum and a drive shaft connecting the variable frequency drive motor and gearbox with the drive wheels to rotate the drum and to obtain the desired drum rotation speed.

The drum support structure includes adjustable positioning means, pivotal and locking means for placing and holding the drum in a selected tilted position with respect to the support structure.

The trommel includes an air knife positioned to direct a relatively high volume of air at the drum to remove residue lodged between the spaced-apart elongate members which form the screened portion of the drum.

The present invention provides the method for screening out coins from a non-ferrous throughput of a resource recovery facility and includes a cylindrical drum rotatable along its longitudinal axis, and having an inlet and an outlet end, and spaced-apart elongate members forming a screen extending between the inlet and outlet ends, and comprises the steps of rotating the cylindrical drum; passing the non-ferrous residue throughput through the inlet end of the drum; screening out coins from the non-ferrous residue throughput as it flows through the interior of the drum; dropping the screened coins through the space between the elongate members; and discharging the remaining non-ferrous residue throughput through the outlet end of the drum.

The method of the present invention includes the step of having the non-ferrous residue throughput forming a progressive helix pattern as it passes through the drum.

The method of the present invention includes the step of adapting the drum to be variably tilted downward in the direction of the throughput discharge.

The method of the present invention includes the step of adjusting the drum rotation speed and tilt angle to control the progressive helix flow pattern.

These and other features and advantages of the present invention will be better understood and its advantages will be more readily appreciated from the detailed description of the preferred embodiment, especially when read with reference to the accompanying drawings. The various features of novelty which characterize the invention are pointed out with particularity in the claims annexed to and forming a part of this disclosure. For a better understanding of the invention, its operating advantages and he specific benefits attained by its uses, reference is made to the accompanying drawings and descriptive matter in which preferred embodiments of the invention are illustrated.

### BRIEF DESCRIPTION OF THE DRAWINGS

FIG. 1 is a side view of the coin recovery trommel;

FIG. 2 is an inlet end view of the coin recovery trommel;

FIG. 3 is a side view of the coin recovery trommel in a tilted position; and

FIG. 4 is an inlet view of the coin recovery trommel in a tilted position.

### DESCRIPTION OF A PREFERRED EMBODIMENT

Reference will hereinafter be made to the accompanying drawings wherein like numerals designate the same or functionally similar elements throughout the various figures.

The present invention resides in the recovery of coins from the non-ferrous residue throughput of a resource recovery facility.

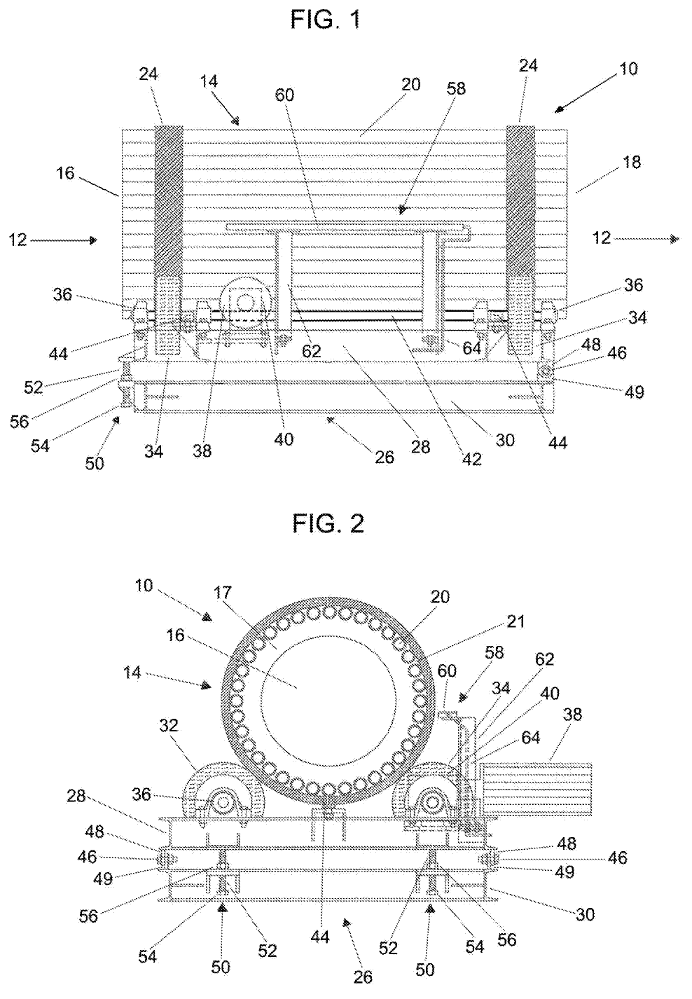

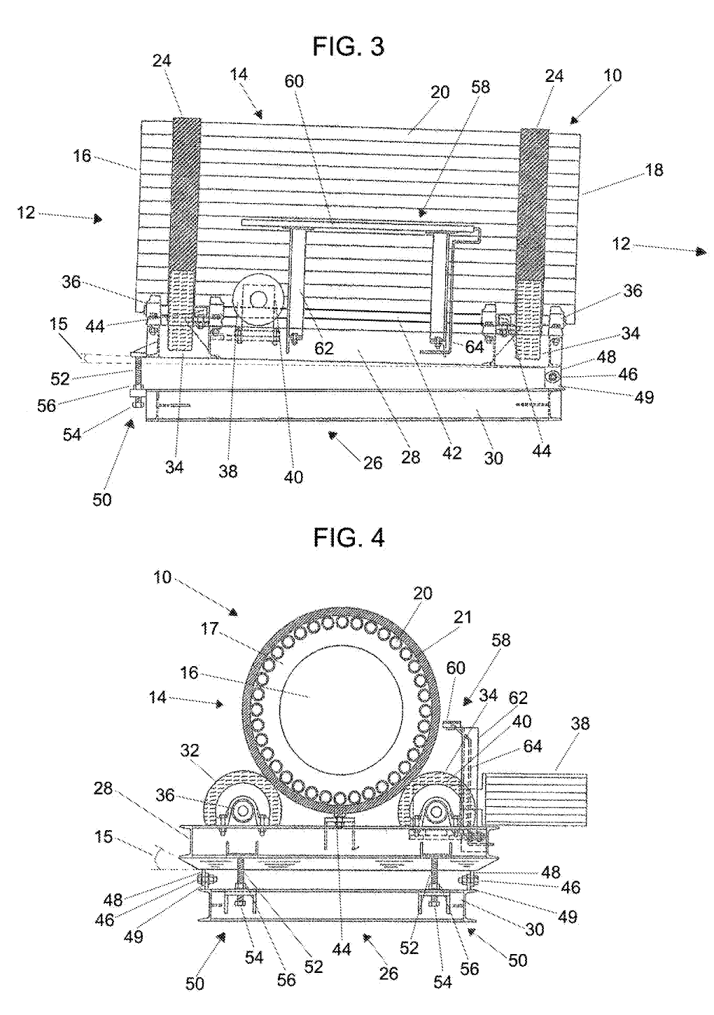

Referring to FIGS. 1-4, there is shown a trommel 10 for screening out coins from a non-ferrous residue throughput 12 of a resource recovery facility, not shown. The trommel 10 includes a cylindrical drum 14 rotatable about its longitudinal axis. The throughput 12 enters the rotating drum 14 through the drum inlet end 16 and exits through the drum outlet end 18. The cylindrical body or circumferential sidewall of the drum 14 forms the drum screening portion, and is comprised of spaced-apart elongate members 20 preferably in the form of pipes with the space 21, shown in FIGS. 2 and 4, between the elongate members or pipes 20, being preferably set at 3/16 of an inch, or determinable by the thickness of the coins sought to be recovered from the non-ferrous residue throughput which is tumbled in a progressive helix pattern as it moves along the length of the rotating drum 14. The helix pattern of the tumbling non-ferrous residue material is determined by the throughput of residue material entering the drum 14, and is controlled by a combination of the speed of rotation of the drum and the tilt angle 15, shown in FIGS. 3 and 4. An annular plate 17, shown in FIGS. 2 and 4, is located at the inlet end 16 of the drum 14 and is preferably welded to every other pipe 20. Since the volume of non-ferrous residue being delivered to the drum 14 may vary and the set helix of the residue flowing through the drum 14 remains constant, slight surges in the residue throughput at the inlet end 16 cause a higher volume at the point of entry to the drum 14, and may result in spillage of residue. The annular plate 17, shown in FIGS. 2 and 4, keeps the residue from spilling out until the progressive helix flow distributes the residue through the drum 14 for discharge through the outlet end 18.

The elongate members or pipes 20 are structurally joined in a predetermined spaced-apart relationship. As shown in FIGS. 1 and 3, collars 24 are fixedly secured to the pipes 20, preferably by welding. The cylindrical body of the drum 14 is thus encircled by the collars 24, which are part of the drive train for rotating the drum 14. The preferred material for the drum 14 and, in particular, the elongated members or pipes 20, and the collars 24, is stainless steel to eliminate magnetic particles entrained by the non-ferrous residue throughput from accumulating between and on the elongate members or pipes 20 and the collars 24 and clogging the space 21 between the pipes 20 and, thus, interfering with the coin recovery process.

The trommel 10 has a support structure 26 which includes an upper frame 28 and a lower frame 30. The drum 14 is wedged at the collars 24 between a pair of idler wheels 32, shown in FIGS. 2 and 4, on one side and a pair of drive wheels 34 on the opposite side to establish a frictional drive between the drive wheels 34 and the collars 24. The idler wheels 32 and the drive wheels 34 are supported through their respective bearings 36 by the upper frame 28 of the trommel support structure 26. The preferred material for the idler and drive wheels 32 and 34 is carbon steel with a urethane coating.

A combination of a variable frequency drive motor 38 and a gear box 40 are positioned on the upper frame 28 of the trommel support structure 26. A drive shaft 42, shown in FIGS. 1 and 3, operatively connects the variable frequency drive motor and gearbox combination to the drive wheels 34 which are frictionally engaged with the collars 24 to rotate and operate the drum 14 at the desired drum rotation speed. The engagement of the two drive wheels 34 with the corresponding collars 24 provide a dual drive system which allows the drum 14 to track evenly and present an even force on both collars 24 during rotation. The rotating drum 14 is kept tracked by a pair of thrust rollers 44. Each of the thrust rollers 44 is mounted on a bracket supported by the upper frame 28 of support structure 26 and is adjacently spaced from the inside edge of a corresponding collar 24. The thrust rollers 44 are spaced away from the inside edge of the collars 24 to allow the drum 14 to track left or right by a small measure. The desired measured spacing of each roller 44 is limited to no more than ¼ inches from the inside edge of the associated collar 24. This measured spacing will allow the drum to rotate in the desired longitudinal position with the least amount of resistance, and thus reduce excessive wear of the collars 24 and the thrust rollers 44.

In accordance with the present invention, the drum 14 is tiltable downward in the direction of the drum outlet end 18, or non-ferrous residue throughput 12 discharge, by a few degrees, for example, two degrees with respect to a horizontal plane. The tilting mechanism is part of the support structure 26 and includes the upper frame 28 having a proximal end pivotally mounted on the lower frame 30. The proximal end of the upper frame 28 is preferably located subjacent to the drum outlet end 18, and is pivotally mounted to the proximal end of the lower frame 30 through pivot bolts 46 that pivotally engage with upper frame tabs 48 with the lower frame tabs 49. A manually adjustable, threadably actuated drive mechanism 50 is engaged with the free distal end of the upper frame 28 which is preferably located subjacent to the drum inlet end 16. The manually adjustable mechanism 50 includes a pair of laterally spaced threaded adjustment bolts 52 engaged with and extending through correspondingly threaded apertures in the distal end of the lower frame 30 and thence across to and bearing against the free distal end of the upper frame 28. The mechanism 50 is such that rotation of the hex head 54 in one direction, preferably clockwise, forces the free distal end of the upper frame 28 upwardly and, in turn, raises the drum inlet end 16 while pivoting the proximal end of the upper frame 28 to attain the desired tilt angle 15 position for the drum 14, as shown in FIGS. 3 and 4. The mechanism 50 includes a threaded locknut 56 engaging each of the adjustment bolts 52 and rotatable thereon to tighten the adjustment bolts 52 relative to the lower frame 30, and thereby holding the drum 14 in the selected tilted position. Alternatively, the mechanism 50 could be a hydraulic, pneumatic, or even an electro mechanical actuator to adjust the pitch of the drum 14. The adjustments can be made when the trommel 10 is running. This would be the preferred method, as the operator can visually watch the throughput 12 and adjust as necessary.

The present invention preferably incorporates a so-called “air-knife” or “air amplifier” of the sort which drives a relatively small volume of air along a wall surface, such that the air adheres to that wall surface. This small volume of air creates suction in the adjacent air which pulls in very high volumes of air along with the relatively small volume of air. Amplifications of air volumes on the order of 30 to 1 may be achieved with such air amplifiers. Such amplifiers have been utilized for blowing off parts to be cleaned. The structure of the amplifier itself is known, and is commonly available on the market. One such amplifier is available under the trade name Exair Air Knife from Exair Corporation of Cincinnati, Ohio.

In accordance with the present invention, the space 21 between the elongated members or pipes 20 is kept clean of residue by an air knife or air amplifier 58 which is located outside of the rotatable drum 14 and includes a thin elongated nozzle 60 facing the pipes 20, preferably along the horizontal centerline of the drum 14 and substantially perpendicular to the axis of rotation of the drum 14. The air knife 58 is positioned such that a relatively high volume of air with hard-hitting force and minimal wind shear is directed by the nozzle 60 at the pipes 20 to remove residue which may be adhering to the pipes 20 and clogging the spaces 21. The air knife 58 thus cleans the spaces 21 just prior to the throughput material 12 tumbling into the spaces 21. Thus, in FIG. 2, the drum 14 rotates in a clockwise direction. If the air knife 58 was located on the opposite side of the drum 14, drum 14 would rotate counterclockwise. The air knife 58 is mounted on a bracket 62 which is supported by the upper frame 28 of the support structure 26, whereby the drum 14 and the air knife 58 tilt in unison. A compressed air supply line 64 delivers compressed air to the air knife 58.

The method of the present invention provides for the screening out of coins from a non-ferrous residue throughput 12 of a resource recovery facility, not shown, and includes a cylindrical drum 14 rotatable along its longitudinal axis, and having an inlet end 16 and an outlet end 18, and spaced-apart elongate members or pipes 20 forming a screen 23 extending between the inlet end 16 and outlet end 18 of the drum 14. The method comprises the steps of rotating the drum 14; passing the non-ferrous residue throughput 12 through the inlet end 16 of the drum 14; screening out coins from the non-ferrous residue throughput 12 as it flows through the interior of the drum 14; dropping the screened coins through the space 21 between the elongate members 20 through a hopper chute, not shown, and into a collection box, not shown. The remaining non-ferrous residue throughput 12 is discharged through the drum outlet 18. The method further comprises the steps of variably tilting the drum 14 downward in the direction non-ferrous residue throughput 12 discharge; the non-ferrous residue throughput 12 forming a progressive helix pattern as it passes through the drum 14; adjusting the drum 14 rotation speed and tilt angle 15, shown in FIGS. 3 and 4, to control the progressive helix flow pattern; securing the drum in the selected position; an air knife 58 directing a relatively high volume of air at the spaced-apart elongate members 20 to remove residue lodged therebetween; and causing the air knife 58 and the drum 14 to tilt in unison.

Although differently sized trommels may be built for various capacities, a trommel has been designed for 0.12 tons per hour of non-ferrous residue throughput. The trommel drum, positioned with a downward tilt of two degrees, and having a diameter of two feet, a length of four feet, and a cylindrical sidewall screen comprised of elongated pipe members spaced-apart by 3/16 of an inch, has successfully screened out coins from the residue throughput flowing therethrough.

Although the present invention has been described above with reference to particular means, materials, and embodiments, it is to be understood that this invention may be varied in many ways without departing from the spirit and scope thereof, and therefore is not limited to these disclosed particulars but extends instead to all equivalents within the scope of the following claims.

I claim:

1. A trommel for screening out coins from a non-ferrous residue throughput comprising a cylindrical drum having an inlet end and an outlet end, spaced-apart elongate members forming a screen extending between the drum inlet and outlet ends, the elongate members being joined by transverse bracing members, the drum being rotatable along its longitudinal axis and positioned such that the residue throughput moves from the inlet end to the outlet end as the drum rotates and tumbles the residue in a progressive helix pattern to cause the screening out of coins from the residue, the screened coins falling through the space between the elongate members, with the remaining residue throughput being discharged through the outlet end of the drum.

2. The trommel according to claim 1, wherein the space between elongate members is about 3/16 inches.

3. The trommel according to claim 1, wherein the elongate members are in the form of pipes.

4. The trommel according to claim 1, wherein the bracing members are in the form of rings.

5. The trommel according to claim 1, wherein the elongate members are comprised of stainless steel.

6. The trommel according to claim 1 wherein the bracing members are comprised of stainless steel.

7. The trommel according to claim 1, including drive means for causing and controlling the rotation of the drum.

8. The trommel according to claim 7 wherein the drive means includes a variable frequency motor and gearbox combination.

9. The trommel according to claim 8, wherein the drive means includes at least one collar fixedly encircling the drum and at least one drive wheel frictionally engaged with the collar.

10. The trommel according to claims 9, wherein the drive means includes a drive shaft connecting the motor and gearbox combination to the drive wheel.

11. The trommel according to claim 9, wherein the collar is composed of stainless steel.

12. The trommel according to claim 9, wherein the drive wheel is composed of carbon steel and includes a coating of urethane.

13. The trommel according to claim 9, wherein the drive means includes an idler wheel contacting the collar on a side opposite the drive wheel.

14. The trommel according to 13, wherein the idler wheel is composed of carbon steel and includes a coating of urethane.

15. The trommel according to claim 8, wherein the drive means includes respective first and second collars fixedly encircling the drum, and corresponding drive wheels frictionally engaged with the collars.

16. The trommel according to claim 15, wherein the drive means includes a drive shaft connecting the motor and gearbox combination to the drive wheels.

17. The trommel according to claim 15, wherein the collars are composed of stainless steel.

18. The trommel according to claim 15, wherein the drive wheels are composed of carbon steel and include a coating of urethane.

19. The trommel according to claim 15, wherein the drive means includes respective idler wheels contacting the first and second collars on sides opposite the drive wheels.

20. The trommel according to claim 19, wherein the idler wheels are composed of carbon steel and include coating of urethane,

21. The trommel according to claim 15, including a corresponding thrust roller adjacently spaced from the inside edge of each of the collars.

22. The trommel according to claim 15, including a corresponding thrust roller positioned about ¼ inches from the inside edge of each of the collars.

23. The trommel according to claim 1, including tilting means for causing the drum to pivot downward in the direction of throughput discharge.

24. The trommel according to claim 23, including an air knife directing a relatively large volume of air at the spaced-apart elongate members to clean the space therebetween, and including means to cause the air knife to tilt in unison with the drum.

25. The trommel according to claim 23, including a drum support structure having an upper frame and a lower frame.

26. The trommel according to claim 25, wherein the tilting means includes having a proximal end of the upper frame pivotally mounted on the lower frame.

27. The trommel according to claim 25, wherein the tilting means includes the upper frame having a free distal end movable relative the lower frame.

28. The trommel according to claim 25, wherein at least one threaded adjustment bolt is threadably engaged with and extends through the lower frame for contacting and pressing against the free distal end of the upper frame to position and support the drum.

29. The trommel according to claim 28, wherein the adjustment bolt is vertically oriented with respect to the lower frame.

30. The trommel according to claim 28, including locking means for holding the drum in a selected position.

31. The trommel according to claim 28, wherein the locking means includes a locknut engaging the adjustment bolt and the lower support frame.

32. The trommel according to claim 1, including a compressed air supply line, an air knife receiving the compressed air from the supply line, the air knife positioned to direct a relatively large volume of air at the spaced-apart elongated members to remove residue lodged therebetween.

33. The trommel according to claim 32, wherein the air knife is formed with an elongated orifice.

34. The trommel according to claim 33, wherein the orifice is elongated in a direction parallel to the longitudinal axis of the drum.

35. The trommel according to claim 23, wherein the tilting means comprise one of mechanical, hydraulic, pneumatic, and electro mechanical actuator means.

36. A method for screening out coins from a non-ferrous residue throughput including a cylindrical drum rotatable along its longitudinal axis and having an inlet end and an outlet end and spaced-apart elongate members forming a screen extending between the inlet and outlet ends, and comprising the steps of:
rotating the cylindrical drum;
passing the non-ferrous residue throughput through the inlet end of the drum;
screening out coins from the non-ferrous residue throughput as it flows through the interior of the drum;
dropping the screened coins through the space between the elongate members; and
discharging the remaining non-ferrous residue throughput through the outlet end of the drum.

37. The method according to claim 36, including the step of having the non-ferrous residue throughput forming a progressive helix flow pattern as it passes through the drum.

38. The method according to claim 36, including the step of adapting the drum to be variably tilted downward in the direction of throughput discharge.

39. The method according to claim 38, including the step of adjusting the drum rotation speed and tilt angle to control the progressive helix flow pattern.

40. The method according to claim 38, including the step of positioning the drum at a selected tilt angle.

41. The method according to claim 38, including the step of positioning the drum at a tilt angle of two degrees with respect to a horizontal plane.

42. The method according to claim 40 or 41, including the step of securing the drum in the selected position.

43. The method according to claim 38, including the step of directing a relatively high volume of air at the spaced-apart elongated members to remove residue lodged therebetween.

44. The method according to claim 43, wherein the relatively high volume of air directed at the spaced-apart elongated members is created by an air knife.

45. The method according to claim 44, including the step of tilting the drum and the air knife in unison.
